(19) United States
(12) Patent Application Publication
(10) Pub. No.: US 2025/0379725 A1
(43) Pub. Date: Dec. 11, 2025

(54) KEYSHARE REFRESH VIA THRESHOLD ENCRYPTION KEY

(71) Applicant: Coinbase, Inc., Oakland, CA (US)

(72) Inventors: Arash Afshar, Calgary (CA); Yehuda Lindell, Petah Tikva (IL); Guy Pe’er, Talmey Yechiel (IL)

(21) Appl. No.: 18/737,841

(22) Filed: Jun. 7, 2024

(51) Int. Cl. H04L 9/08; H04L 9/06

(52) U.S. Cl. CPC H04L 9/0825; H04L 9/0618

(57) ABSTRACT

Methods, systems, and devices for key management are described. A party having a key share of multiple key shares of a cryptographic key may encrypt a key share via a public threshold encryption key. The party may transmit, in accordance with a multi-party computation (MPC) operation, requests to multiple parties having private key shares of a private threshold decryption key corresponding to the public threshold encryption key. The party may receive multiple partial decryption results from a subset of the parties having the private key shares of the private threshold decryption key. The party may combine the partial decryption results to generate the key share and execute a portion of the MPC operation using the generated key share. Executing the portion of the MPC operation may cause a key share refresh operation for the key share of the cryptographic key.

### FIELD OF TECHNOLOGY

The present disclosure relates generally to data management, including techniques for keyshare refresh via threshold encryption key.

### BACKGROUND

Blockchains and related technologies may be employed to support recordation of ownership of digital assets, such as cryptocurrencies, fungible tokens, non-fungible tokens (NFTs), and the like. Generally, peer-to-peer networks support transaction validation and recordation of transfer of such digital assets on blockchains. Various types of consensus mechanisms may be implemented by the peer-to-peer networks to confirm transactions and to add blocks of transactions to the blockchain networks. Example consensus mechanisms include the proof-of-work consensus mechanism implemented by the Bitcoin network and the proof-of-stake mechanism implemented by the Ethereum network. Some nodes of a blockchain network may be associated with a digital asset exchange, which may be accessed by users to trade digital assets or trade a fiat currency for a digital asset.

### BRIEF DESCRIPTION OF THE DRAWINGS

FIG. 1 illustrates an example of a computing environment that supports keyshare refresh via threshold encryption key in accordance with aspects of the present disclosure.

FIG. 2 shows an example of a key share refresh operation that supports keyshare refresh via threshold encryption key in accordance with aspects of the present disclosure.

FIG. 3 shows an example of a process flow that supports keyshare refresh via threshold encryption key in accordance with aspects of the present disclosure.

FIG. 4 shows a block diagram of an apparatus that supports keyshare refresh via threshold encryption key in accordance with aspects of the present disclosure.

FIG. 5 shows a block diagram of a key share refresh manager that supports keyshare refresh via threshold encryption key in accordance with aspects of the present disclosure.

FIG. 6 shows a diagram of a system including a device that supports keyshare refresh via threshold encryption key in accordance with aspects of the present disclosure.

FIGS. 7 through 9 show flowcharts illustrating methods that support keyshare refresh via threshold encryption key in accordance with aspects of the present disclosure.

### DETAILED DESCRIPTION

In some examples, multiple parties in a multi-party computation (MPC) scheme may collaborate to perform an MPC operation. As part of the MPC scheme, a cryptographic key may be distributed, via multiple key shares, to the multiple parties. For example, a cryptographic key, which may be an example of a secret signing key or a secret encryption key, may be split into multiple parts via a key sharing operation, such as Shamir sharing, additive sharing, multiplicative sharing, or the like. In some cases, a threshold quantity or all of the multiple parties having the key shares of the cryptographic key (i.e., t out of n key shares) may, together, perform an MPC operation. In other words, the threshold quantity of key shares may be required to execute the MPC operation. As described herein, “party” may refer to a participant in a protocol or scheme, such as a signer, a verifier, a sender, a receiver, or the like, and the participant may be a computing device (e.g., logical or physical computing system) that operates autonomously or with user input. Additionally, a “key share” may refer to a part or portion of a key or secret value, and may be used interchangeably with “key shard” or “key part.”

In a first example of an MPC operation, the threshold quantity of the multiple parties may perform a signing operation, which may be part of a threshold signing scheme. For example, the threshold quantity of the multiple parties may generate a signature for a message via the key shares of the respective parties (e.g., a threshold quantity of key shares). In such examples, the cryptographic key corresponding to the key shares may be a signing key. A verifier may validate the authenticity of the signature via a public key, such as a public verification key, corresponding to the signing key. In other words, the public verification key corresponding to the signing key may be used to verify whether the signature was produced by the signing key. In a second example of an MPC operation, the threshold quantity of the multiple parties may perform a decryption operation, which may be part of a threshold encryption scheme. For example, the threshold quantity of the multiple parties may decrypt a message via the key shares of the respective parties (e.g., a threshold quantity of key shares). In such examples, the cryptographic key corresponding to the key shares may be a decryption key. The threshold quantity of the multiple parties may decrypt a ciphertext included in a request to decrypt the message and obtain the message in plaintext. The message may be encrypted via a public key, such as a public encryption key, corresponding to the decryption key. In some cases, the threshold encryption scheme may be an example of a symmetric encryption scheme in which an encryption key and a decryption key are a same key.

The parties of the MPC scheme may perform or be subject to a key share refresh operation. For example, a key share refresh operation may refer to generation of new key shares which are different from previous key shares but correspond to the same key. In the example of the MPC scheme, the parties having the key shares may generate new key shares corresponding to the same cryptographic key as the original key shares. In some cases, the key share refresh operation may support proactive security. For example, the key shares may be refreshed before an attacker obtains the threshold quantity of key shares associated with execution of the MPC operation. In other words, while the attacker may obtain a first key share and, at a later time, a second key share, but the first key share may not be compatible with the second key share due to a key share refresh operation occurring before the second key share is obtained. However, the key share refresh operation may be associated with a high level of complexity. For example, the multiple parties of the MPC scheme may coordinate in order to perform the key share refresh operation, which may be complex in examples in which a large quantity of parties are involved in the MPC scheme and/or when the parties manage multiple different key shares of different keys. Additionally, generation of new key shares on a periodic basis (i.e., regardless of whether the key shares have been used) may be complex computationally.

As described herein, the multiple parties of the MPC scheme may generate encrypted key shares via a public threshold encryption key. For example, the parties having the key shares of the cryptographic key may obtain encrypted key shares by encrypting respective key shares via the public threshold encryption key. The key share refresh operation may involve refreshing key shares after use (e.g., rather than periodically). For example, a party may use a key share to perform a portion of an MPC operation, obtain a new key share via a key share refresh operation, and encrypt the new key share via the public threshold encryption key. The public threshold encryption key may correspond to a private threshold decryption key. The private threshold decryption key may be distributed, via multiple key shares, to multiple parties. The key shares of the private threshold decryption key may perform or be subject to the same or a different key share refresh operation. For example, the key shares of the private threshold decryption key may be replaced (e.g., periodically), where the new or refreshed key shares correspond to the same private threshold decryption key.

To use a key share of the cryptographic key encrypted via the public threshold encryption key, a party may send a request to the multiple parties having the key shares of the private threshold decryption key. A subset of the parties having the key shares of the private threshold decryption key may provide, in response to the request, partial decryptions. The party may combine the partial decryptions to generate the key share (i.e., the decrypted key share) and execute a portion of an MPC operation using the generated key share. After using the key share, the party may obtain a new key share and encrypt the new key share via the public threshold encryption key. By refreshing the key shares of the private threshold decryption key, techniques described herein may support an efficient key share refresh operation for large quantities of key shares. For example, refreshing the private threshold decryption key may be more efficient than refreshing each individual key share of the cryptographic key, especially in examples in which there are large quantities of key shares of the cryptographic key.

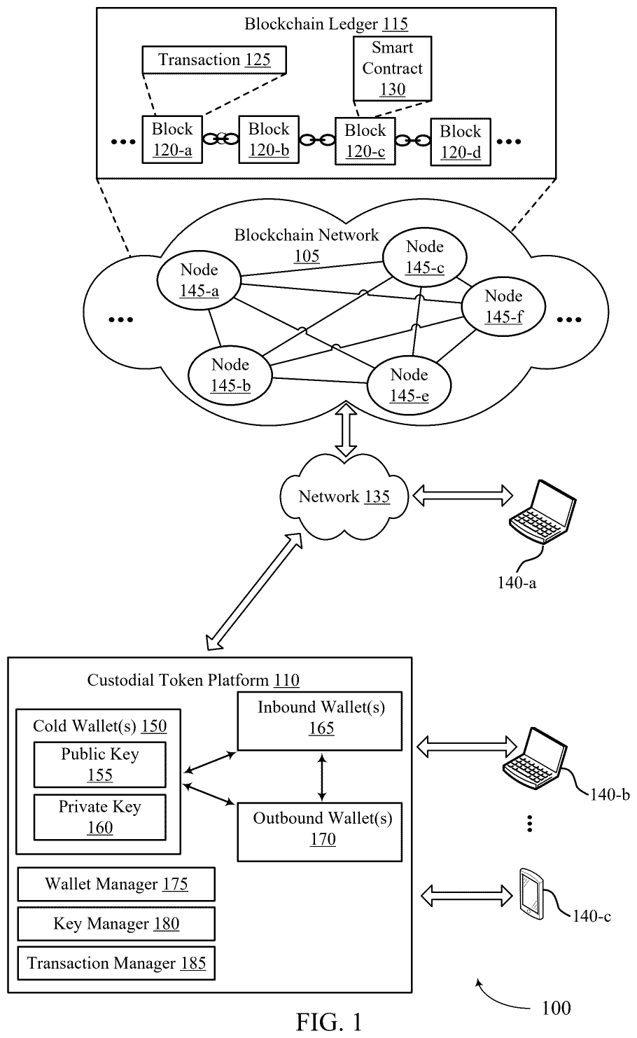

FIG. 1 illustrates an example of a computing environment 100 that supports keyshare refresh via threshold encryption key in accordance with aspects of the present disclosure. The computing environment 100 may include a blockchain network 105 that supports a blockchain ledger 115, a custodial token platform 110, and one or more computing devices 140, which may be in communication with one another via a network 135.

The network 135 may allow the one or more computing devices 140, one or more nodes 145 of the blockchain network 105, and the custodial token platform 110 to communicate (e.g., exchange information) with one another. The network 135 may include aspects of one or more wired networks (e.g., the Internet), one or more wireless networks (e.g., cellular networks), or any combination thereof. The network 135 may include aspects of one or more public networks or private networks, as well as secured or unsecured networks, or any combination thereof. The network 135 also may include any quantity of communications links and any quantity of hubs, bridges, routers, switches, ports or other physical or logical network components.

Nodes 145 of the blockchain network 105 may generate, store, process, verify, or otherwise use data of the blockchain ledger 115. The nodes 145 of the blockchain network 105 may represent or be examples of computing systems or devices that implement or execute a blockchain application or program for peer-to-peer transaction and program execution. For example, the nodes 145 of the blockchain network 105 support recording of ownership of digital assets, such as cryptocurrencies, fungible tokens, non-fungible tokens (NFTs), and the like, and changes in ownership of the digital assets. The digital assets may be referred to as tokens, coins, crypto tokens, or the like. The nodes 145 may implement one or more types of consensus mechanisms to confirm transactions and to add blocks (e.g., blocks 120-a, 120-b, 120-c, and so forth) of transactions (or other data) to the blockchain ledger 115. Example consensus mechanisms include a proof-of-work consensus mechanism implemented by the Bitcoin network and a proof-of-stake consensus mechanism implemented by the Ethereum network.

When a device (e.g., the computing device 140-a, 140-b, or 140-c) associated with the blockchain network 105 executes or completes a transaction associated with a token supported by the blockchain ledger, the nodes 145 of the blockchain network 105 may execute a transfer instruction that broadcasts the transaction (e.g., data associated with the transaction) to the other nodes 145 of the blockchain network 105, which may execute the blockchain application to verify the transaction and add the transaction to a new block (e.g., the block 120-d) of a blockchain ledger (e.g., the blockchain ledger 115) of transactions after verification of the transaction. Using the implemented consensus mechanism, each node 145 may function to support maintaining an accurate blockchain ledger 115 and prevent fraudulent transactions.

The blockchain ledger 115 may include a record of each transaction (e.g., a transaction 125) between wallets (e.g., wallet addresses) associated with the blockchain network 105. Some blockchains may support smart contracts, such as smart contract 130, which may be an example of a sub-program that may be deployed to the blockchain and executed when one or more conditions defined in the smart contract 130 are satisfied. For example, the nodes 145 of the blockchain network 105 may execute one or more instructions of the smart contract 130 after a method or instruction defined in the smart contract 130 is called by another device. In some examples, the blockchain ledger 115 is referred to as a blockchain distributed data store.

A computing device 140 may be used to input information to or receive information from the computing system custodial token platform 110, the blockchain network 105, or both. For example, a user of the computing device 140-a may provide user inputs via the computing device 140-a, which may result in commands, data, or any combination thereof being communicated via the network 135 to the computing system custodial token platform 110, the blockchain network 105, or both. Additionally, or alternatively, a computing device 140-a may output (e.g., display) data or other information received from the custodial token platform 110, the blockchain network 105, or both. A user of a computing device 140-a may, for example, use the computing device 140-a to interact with one or more user interfaces (e.g., graphical user interfaces (GUIs)) to operate or otherwise interact with the custodial token platform 110, the blockchain network 105, or both.

A computing device 140 and/or a node 145 may be a stationary device (e.g., a desktop computer or access point) or a mobile device (e.g., a laptop computer, tablet computer, or cellular phone). In some examples, a computing device 140 and/or a node 145 may be a commercial computing device, such as a server or collection of servers. And in some examples, a computing device 140 and/or a node 145 may be a virtual device (e.g., a virtual machine).

Some blockchain protocols support layer one and layer two crypto tokens. A layer one token is a token that is supported by its own blockchain protocol, meaning that the layer one token (or a derivative thereof), may be used to pay transaction fees for transacting using the blockchain protocol. A layer two token is a token that is built on top of layer one, for example, using a smart contract 130 or a decentralized application (“Dapp”). The smart contract 130 or decentralized application may issue layer two tokens to various users based on various conditions, and the users may transact using the layer two tokens, but transaction fees may be based on the layer one token (or a derivative thereof).

The custodial token platform 110 may support exchange or trading of digital assets, fiat currencies, or both by users of the custodial token platform 110. The custodial token platform 110 may be accessed via website, web application, or applications that are installed on the one or more computing devices 140. The custodial token platform 110 may be configured to interact with one or more types of blockchain networks, such as the blockchain network 105, to support digital asset purchase, exchange, deposit, and withdrawal.

For example, users may create accounts associated with the custodial token platform 110 such as to support purchasing of a digital asset via a fiat currency, selling of a digital asset via fiat currency, or exchanging or trading of digital assets. A key management service (e.g., a key manager) of the custodial token platform 110 may create, manage, or otherwise use private keys that are associated with user wallets and internal wallets. For example, if a user wishes to withdraw a token associated with the user account to an external wallet address, key manager 180 may sign a transaction associated with a wallet of the user, and broadcast the signed transaction to nodes 145 of the blockchain network 105, as described herein. In some examples, a user does not have direct access to a private key associated with a wallet or account supported or managed by the custodial token platform 110. As such, user wallets of the custodial token platform 110 may be referred to non-custodial wallets or non-custodial addresses.

The custodial token platform 110 may create, manage, delete, or otherwise use various types of wallets to support digital asset exchange. For example, the custodial token platform 110 may maintain one or more internal cold wallets 150. The internal cold wallets 150 may be an example of an offline wallet, meaning that the cold wallet 150 is not directly coupled with other computing systems or the network 135 (e.g., at all times). The cold wallet 150 may be used by the custodial token platform 110 to ensure that the custodial token platform 110 is secure from losing assets via hacks or other types of unauthorized access and to ensure that the custodial token platform 110 has enough assets to cover any potential liabilities. The one or more cold wallets 150, as well as other wallets of the blockchain network 105 may be implemented using public key cryptography, such that the cold wallet 150 is associated with a public key 155 and a private key 160. The public key 155 may be used to publicly transact via the cold wallet 150, meaning that another wallet may enter the public key 155 into a transaction such as to move assets from the wallet to the cold wallet 150. The private key 160 may be used to verify (e.g., digitally sign) transactions that are transmitted from the cold wallet 150, and the digital signature may be used by nodes 145 to verify or authenticate the transaction. Other wallets of the custodial token platform 110 and/or the blockchain network 105 may similarly use aspects of public key cryptography.

The custodial token platform 110 may also create, manage, delete, or otherwise use inbound wallets 165 and outbound wallets 170. For example, a wallet manager 175 of the custodial token platform 110 may create a new inbound wallet 165 for each user or account of the custodial token platform 110 or for each inbound transaction (e.g., deposit transaction) for the custodial token platform 110. In some examples, the custodial token platform 110 may implement techniques to move digital assets between wallets of the digital asset exchange platform. Assets may be moved based on a schedule, based on asset thresholds, liquidity requirements, or a combination thereof. In some examples, movements or exchanges of assets internally to the custodial token platform 110 may be “off-chain” meaning that the transactions associated with the movement of the digital asset are not broadcast via the corresponding blockchain network (e.g., blockchain network 105). In such cases, the custodial token platform 110 may maintain an internal accounting (e.g., ledger) of assets that are associated with the various wallets and/or user accounts.

As used herein, a wallet, such as inbound wallets 165 and outbound wallets 170 may be associated with a wallet address, which may be an example of a public key, as described herein. The wallets may be associated with a private key that is used to sign transactions and messages associated with the wallet. A wallet may also be associated with various user interface components and functionality. For example, some wallets may be associated with or leverage functionality for transmitting crypto tokens by allowing a user to enter a transaction amount, a receiver address, etc. into a user interface and clicking or activating a UI component such that the transaction is broadcast via the corresponding blockchain network via a node (e.g., a node 145) associated with the wallet. As used herein, “wallet” and “address” may be used interchangeably.

In some cases, the custodial token platform 110 may implement a transaction manager 185 that supports monitoring of one or more blockchains, such as the blockchain ledger 115, for incoming transactions associated with addresses managed by the custodial token platform 110 and creating and broadcasting on-blockchain transactions when a user or customer sends a digital asset (e.g., a withdrawal). For example, the transaction manager 185 may monitor the addressees of the customers for transfer of layer one or layer two tokens supported by the blockchain ledger 115 to the addresses managed by the custodial token platform 110. As another example, when a user is withdrawing a digital asset, such as a layer one or layer two token, to an external wallet (e.g., an address that is not managed by the custodial token platform 110 or an address for which the custodial token platform 110 does not have access to the associated private key), the transaction manager 185 may create and broadcast the transaction to one or more other nodes 145 of the blockchain network 105 in accordance with the blockchain application associated with the blockchain network 105. As such, the transaction manager 185, or an associated component of the custodial token platform 110 may function as a node 145 of the blockchain network 105.

As described herein, the custodial token platform may implement and support various wallets including the inbound wallets 165, the outbound wallets 170, and the cold wallets 150. Further, the custodial token platform 110 may implement techniques to maintain and manage balances of the various wallets. In some examples, the balances of the various wallets are configured to support security and liquidity. For example, the custodial token platform 110 may implement transactions that move crypto tokens between the inbound wallets 165 and the outbound wallets 170. These transactions may be referred to as “flush” transactions and may occur on a periodic or scheduled basis.

As described herein, various transactions may be broadcast to the blockchain ledger 115 to cause transfer of crypto tokens, to call smart contracts, to deploy smart contracts etc. In some examples, these transactions may also be referred to as messages. That is, the custodial token platform 110 may broadcast a message to the blockchain network 105 to cause transfer of tokens between wallets managed by the custodial token platform 110 to an external wallet, to deploy a smart contract (e.g., a self-executing program), or to call a smart contract.

As described herein, a party having a key share of multiple key shares of a cryptographic key may encrypt a key share via a public threshold encryption key, such as a public key of a threshold encryption scheme. The party may transmit, in accordance with an MPC operation, requests to multiple parties having private key shares of a private threshold decryption key corresponding to the public threshold encryption key. The party may receive multiple partial decryption results from a subset of the parties having the private key shares of the private threshold decryption key. The party may combine the partial decryption results to generate the key share and execute a portion of the MPC operation using the generated key share. Executing the portion of the MPC operation may cause or result in a key share refresh operation for the key share of the cryptographic key. In some examples, the key share refresh operation may be executed at the custodial token platform 110, a client application of the custodial token platform 110, or both. Additionally, or alternatively, the party having the key share may perform one or more operations described herein, such as transmit requests, receive partial decryption results, execute a portion of an MPC operation, or the like via the computing device 140. In some examples, the MPC operation may be associated with operations of the custodial token platform 110. For example, the MPC operation may be used to sign a transaction that is to be broadcast via the blockchain network 105 such as to transfer an amount of crypto tokens. The MPC operations may be used to parties with a large amount of funds controlled or managed in association with the custodial token platforms, such as accredited investors, fund managers, etc., such as to improve security. For example, multiple fund managers may be required to sign (e.g., via a MPC operation) a transaction to move an amount of funds.

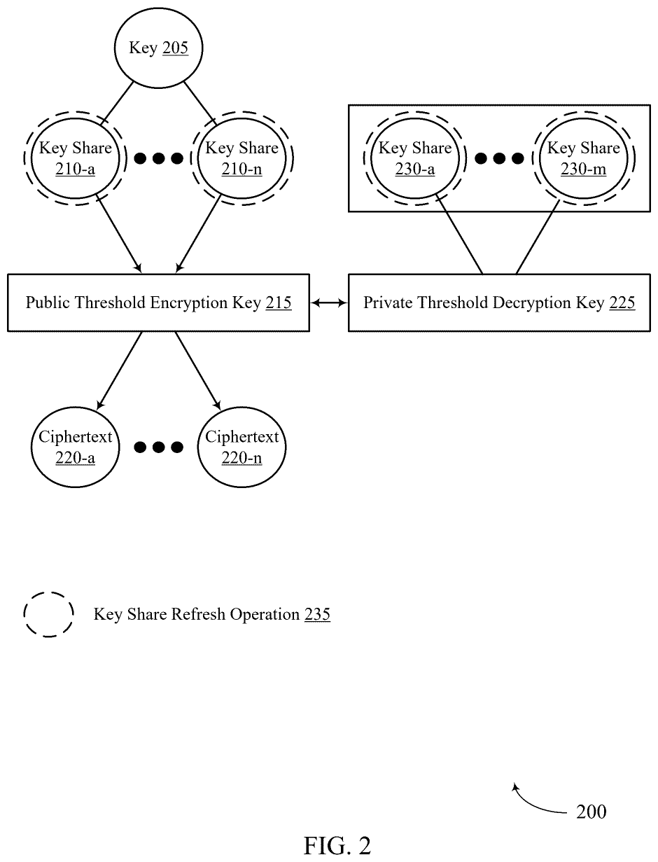

FIG. 2 shows an example of a key share refresh operation 200 that supports keyshare refresh via threshold encryption key in accordance with aspects of the present disclosure. The key share refresh operation 200 may implement or be implemented by one or more devices or systems as described with reference to FIG. 1. For example, the key share refresh operation 200 may be implemented via a computing device by one or more parties having key shares, where the computing device may be an example of the computing device 140 as described with reference to FIG. 1. In some examples, the key share refresh operation 200 may be implemented in the custodial token platform 110. For example, the parties may perform MPC operations via the custodial token platform 110, via a client application of the custodial token platform 110, or the like. In some other examples, the key share refresh operation 200 may be implemented in environments other than the custodial token platform 110. For example, the key share refresh operation 200 may be implemented in other environments that perform MPC operations.

In the example key share refresh operation 200 described with reference to FIG. 2, a key 205 may be split into multiple key shares, including a key share 210-a through a key share 210-n. For example, the key 205 may refer to a key k, and the key share 210-a through the key share 210-n may refer to k₁, . . . , kₙ secret key shares of n different parties. The key share 210-a through the key share 210-n may be distributed to the n different parties via secret sharing (e.g., may be secret shared). The key 205 may refer to a cryptographic key, a signing key, an encryption key, or the like. Additionally, or alternatively, the key 205 may correspond to a public key, such as a corresponding public verification or decryption key, Q. In some examples, the key share 210-a through the key share 210-n of the key 205 may be part of a threshold scheme. For example, a threshold quantity of the key shares tₙ may be required to perform an MPC operation, such as a signing or decryption operation. While a single key 205 is illustrated and described with reference to FIG. 2, it may be understood that the key share refresh operation 200 may involve more than one (i.e., multiple) cryptographic keys. That is, the key share refresh operation 200 described with reference to FIG. 2 may be applicable to one key 205 or multiple different keys.

The key share refresh operation 200 may include a public threshold encryption key 215. The public threshold encryption key 215 may be an example of a public encryption key of a threshold encryption scheme. For example, the public threshold encryption key 215, ptek, may correspond to a private threshold decryption key 225, stek. The private threshold decryption key 225 may be an example of a private decryption key of the threshold encryption scheme. The private threshold decryption key 225 may be split into multiple key shares, including a key share 230-a through a key share 230-m. For example, the private threshold decryption key 225 may refer to a key stek, and the key share 230-a through the key share 230-m may refer to skek₁, . . . , skekₘ secret key shares of m different parties. The key share 230-a through the key share 230-m may be distributed to the m different parties via secret sharing (e.g., may be secret shared). The n different parties at which the shares of the key 205 are distributed may be of a same or different quantity than the m different parties at which the shares of the private threshold decryption key 225 are distributed.

The n parties having the key share 210-a through the key share 210-n of the key 205 may encrypt the key shares via the public threshold encryption key 215. For example, a first party having the key share 210-a may generate an encrypted key share via the public threshold encryption key 215 and an n^{th} party having the key share 210-n may generate an encrypted key share via the public threshold encryption key 215. The parties having the key shares may, as a result of encrypting the key shares via the public threshold encryption key 215, obtain a ciphertext. For example, the first party having the key share 210-a may obtain a ciphertext 220-a based on encrypting the key share 210-a via the public threshold encryption key and the n^{th} party having the key share 210-n may obtain a ciphertext 220-n based on encrypting the key share 210-n via the public threshold encryption key 215. In other words, the n parties may obtain ciphertexts c₁, . . . , cₙ by encrypting the key shares k₁, . . . , kₙ via the public threshold encryption key 215 ptek. The parties may store the ciphertext 220-a through the ciphertext 220-n at a central location or distributed amongst the parties. That is, the ciphertexts c₁, . . . , cₙ may be stored by the respective party which generated them by encrypting the respective key share via the public threshold encryption key 215 or at a same location. Additionally, or alternatively, the n parties having the key share 210-a through the key share 210-n may store encrypted key shares (i.e., encrypted via the public threshold encryption key 215), such as rather than an unencrypted version of a key share.

To use an encrypted key share, the n^{th} party of the multiple n parties having the key share 210-a through the key share 210-n of the key 205 may send requests to the multiple m parties having the key share 230-a through the key share 230-m of the private threshold decryption key 225. For example, to decrypt an encrypted key share and perform a portion of an MPC operation using the key share, the n^{th} party may request decryptions of the encrypted key share. The request may include a ciphertext obtained via encryption of the key share, such as the ciphertext 220-n, cy, corresponding to the encrypted key share of the key share 210-n of the n^{th} party. In some examples, a threshold quantity of parties tₘ may be required to perform partial decryptions of the encrypted key share. For example, the n^{th} party may generate the key share 210-n (e.g., decrypted key share) by combining a quantity of partial decryptions from the threshold quantity of parties tₘ having key shares of the key share 230-a through the key share 230-m of the private threshold decryption key 225.

One or more other parties may obtain respective key shares by requesting the partial decryptions from the m parties having the key share 230-a through the key share 230-m of the private threshold decryption key. For example, a threshold quantity of parties tₙ of the n parties having the key share 210-a through the key share 210-n of the key 205 may obtain respective key shares and perform portions of the MPC operation using the respective key shares. That is, the threshold quantity of parties tₙ may each obtain the respective key shares via partial decryptions from the threshold quantity of parties tₘ. Using the obtained key shares, the threshold quantity of parties tₙ may perform respective portions of the MPC operation. For example, the threshold quantity of parties tₙ may generate partial signatures or partial decryptions as part of a threshold signing scheme or threshold decryption scheme, respectively.

After performing the respective portions of the MPC operation, one or more of the n parties may perform a key share refresh operation 235. The key share refresh operation 235 may involve replacing (e.g., refreshing) key shares of the key 205 such that new key shares still generate the key share 205. For example, prior to the key share refresh operation 235, the key 205 including the key share 210-a through the key share 210-n may be represented as k=k₁+ . . . +kₙ. After the key share refresh operation 235, the key 205 including new key shares may be represented as k=k′₁+ . . . +k′ₙ. As an example, the n^{th} party may perform the key share refresh operation 235 to refresh the key share 210-n after performing the portion of the MPC operation. Performing the key share refresh operation 235 may involve replacing the key share 210-n, kₙ, with a new key share, k′ₙ. In some examples, the n^{th} party may encrypt (e.g., re-encrypt) the new key share via the public threshold encryption key 215. For example, the n^{th} party may obtain a ciphertext c′ₙ corresponding to the new key share k′ₙ. In some examples, the key share refresh operation 235 may be performed at the parties involved in the MPC operation. That is, of the n parties having the key share 210-a through the key share 210-n, only the threshold quantity of parties tₙ may perform the MPC operation, and, accordingly, may perform the key share refresh operation 235. In other words, tₙ-n parties of the n parties may not perform the key share refresh operation 235.

Additionally, or alternatively, one or more of the m parties may perform the key share refresh operation 235. The key share refresh operation 235 may involve replacing (e.g., refreshing) key shares of the private threshold decryption key 225 such that new key shares still generate the private threshold decryption key 225. For example, prior to the key share refresh operation 235, the private threshold decryption key 225 including the key share 230-a through the key share 230-m may be represented as skek=skek₁+ . . . +skekₘ. After the key share refresh operation 235, the key 205 including new key shares may be represented as skek=skek′₁+ . . . +skek′ₘ. As an example, an m^{th} party may perform the key share refresh operation 235 to refresh the key share 230-m. Performing the key share refresh operation 235 may involve replacing the key share 230-m, skekₘ, with a new key share, skek′ₘ. In some examples, one or more of the m parties may perform the key share refresh operation 235 on a periodic basis.

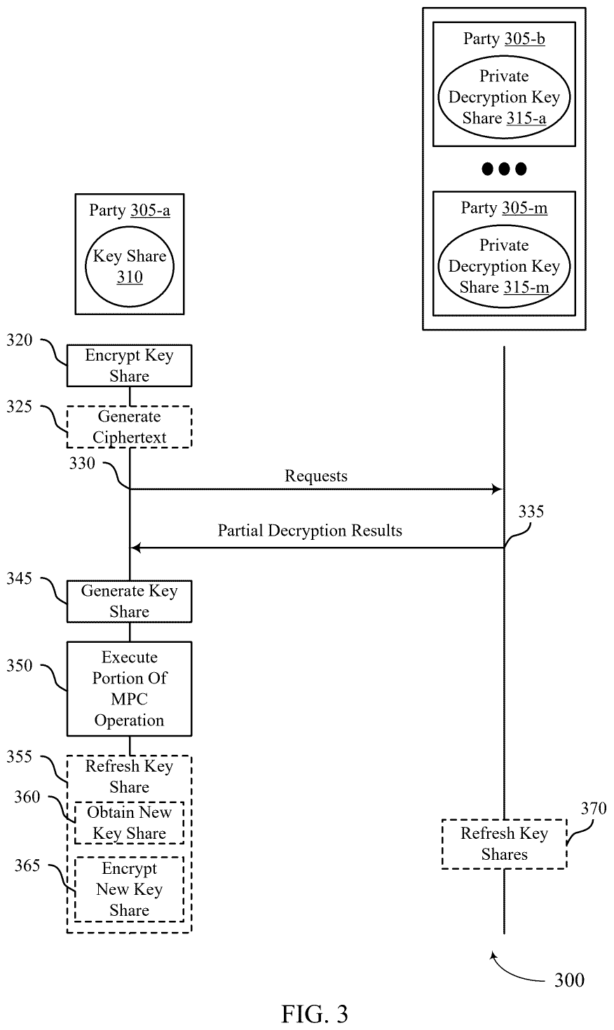

FIG. 3 shows an example of a process flow 300 that supports keyshare refresh via threshold encryption key in accordance with aspects of the present disclosure. In some examples, the process flow 300 may implement or be implemented computing environment 100, the key share refresh operation 200, or both. For example, the process flow 300 may include multiple parties having key shares, which may be examples of the key shares as described with reference to FIG. 2.

Alternative examples of the following may be implemented, where some operations are performed in a different order than described or are not performed at all. In some cases, operations may include additional features not mentioned below, or further operations may be added. Although a party 305-a and a party 305-b through a party 305-m are shown performing the operations of the process flow 300, some aspects of some operations may also be performed by one or more other components.

At 320, the party 305-a may encrypt the key share 310. For example, the party 305-a may encrypt the key share 310 via a public threshold encryption key. The public threshold encryption key may be an example of the public threshold encryption key 215 as described with reference to FIG. 2. In some examples, the key share 310 may be of multiple key shares associated with a cryptographic key. For example, the multiple key shares of the cryptographic key may be an example of the key share 210-a through the key share 210-n of the key 205 as described with reference to FIG. 2.

At 325, the party 305-a may generate a ciphertext. For example, the party 305-a may generate, as a result of encrypting the key share via the public threshold encryption key, a first ciphertext. The first ciphertext may be an example of the ciphertext 220-a or the ciphertext 220-n as described with reference to FIG. 2.

At 330, the party 305-a may transmit requests to the party 305-b through the party 305-m. For example, the party 305-a may transmit, in accordance with an MPC operation, one or more requests to multiple parties having respective private key shares of a private threshold decryption key corresponding to the public threshold decryption key. For example, the respective private key shares of the private threshold decryption key may be an example of the key share 230-a through the key share 230-m of the private threshold decryption key 225 as described with reference to FIG. 2. In some examples, the one or more requests may include the ciphertext generated at 325.

After receiving the one or more requests at 330, the party 305-b through the party 305-m may decrypt the ciphertext associated with the request. For example, the party 305-b may decrypt the ciphertext using the private decryption key share 315-a corresponding to the public threshold encryption key. The private decryption key share 315-a through the private decryption key share 315-m may be examples of the key share 230-a through the key share 230-m of the private threshold decryption key 225 as described with reference to FIG. 2. The private decryption key share 315-a through the private decryption key share 315-m may be shares of a private decryption key of a threshold encryption scheme. After decrypting the ciphertext, the party 305-b may transmit a partial decryption result to the party 305-a.

The threshold encryption scheme, as described with respect to the public threshold encryption key and the private threshold decryption key, may be used to protect the key shares of the cryptographic key, such as the key share 310. For example, by requiring a threshold quantity of partial decryption results, the threshold encryption scheme may support secure use of the key share 310. That is, the key share 310, in an unencrypted form, is revealed to the party 305-a by combining the partial decryptions. Accordingly, the unencrypted form of the key share 310 is not revealed to the party 305-b through the party 305-m. Additionally, after use of the key share 310, a new version of the key share 310 is generated via the key share refresh operation, ensuring that the unencrypted form of the key share 310 generated via the combined partial decryption results may not be reused.

At 335, the party 305-a may receive partial decryption results. For example, the party 305-a may receive, in response to the one or more requests, multiple partial decryption results from at least a subset of the multiple parties having the respective private key shares of the private threshold decryption key. The subset of the multiple parties may partially decrypt, via the respective private key shares of the private threshold decryption key, the ciphertext included in the request. In other words, the subset of the multiple parties may each generate a partial decryption for the key share 310 based on the ciphertext. In some examples, a quantity of the subset of the multiple parties may satisfy a threshold quantity of decryption results combinable to generate the key share 310.

At 345, the party 305-a may generate a key share. For example, the party 305-a may combine the multiple partial decryption results to generate the key share 310. After generating the key share, the party 305-a may execute a portion of the MPC operation. For example, the party 305-a may execute the portion of the MPC operation using the key share resulting from the combination of the multiple partial decryption results.

In some examples, the MPC operation may be executed in accordance with a threshold quantity of portions of the MPC operation using a threshold quantity of key shares of the cryptographic key. The MPC operation may be an example of a signing operation. For example, executing the portion of the MPC operation at 350 may involve executing a signing operation using the key share 310 resulting from the combination of the multiple partial decryption results. Additionally, or alternatively, the MPC operation may be an example of a decryption operation. For example, executing the portion of the MPC operation at 350 may include executing a decryption operation using the key share 310 resulting from the combination of the multiple partial decryption results.

The decryption operation may be an example of or referred to as a threshold encryption scheme. For example, the threshold encryption scheme involving the key share 310 of the cryptographic key may involve performance of a cryptographic operation using the decrypted key share. The threshold encryption scheme involving the key share 310 may be different than the threshold encryption scheme as described with respect to the public threshold encryption key and the private threshold decryption key. For example, the threshold encryption schemes may both involve subsets of parties having shares of a key. However, the threshold encryption scheme involving the public threshold encryption key and the private threshold decryption key may be associated with secure use of the key share 310, whereas the threshold encryption scheme involving the key share 310 may be associated with performance of a cryptographic operation (e.g., or a portion thereof) using the decrypted key share.

At 355, the party 305-a may refresh the key share. For example, at 360, the party 305-a may obtain, after executing the portion of the MPC operation at 350 and in accordance with a key share refresh operation for the cryptographic key, a new key share of the cryptographic key. The key share refresh operation may be an example of the key share refresh operation 235 as described with reference to FIG. 2. For example, the key share refresh operation may involve replacing the key shares of the cryptographic key with new key shares which replace the multiple key shares of the cryptographic key (e.g., including the key share 310). Additionally, at 365, the party 305-a may encrypt the new key share. For example, the party 305-a may encrypt the new key share using the public threshold encryption key.

At 370, the party 305-b through the party 305-m may obtain new private key shares of the private threshold decryption key. For example, the party 305-b may obtain a new key share replacing the private decryption key share 315-a. In some examples, the party 305-b through the party 305-m may obtain the new private key shares in accordance with a key share refresh operation for the private threshold decryption key. The key share refresh operation may occur periodically, or the key share refresh operation may occur after transmission of partial decryption results (e.g., after use).

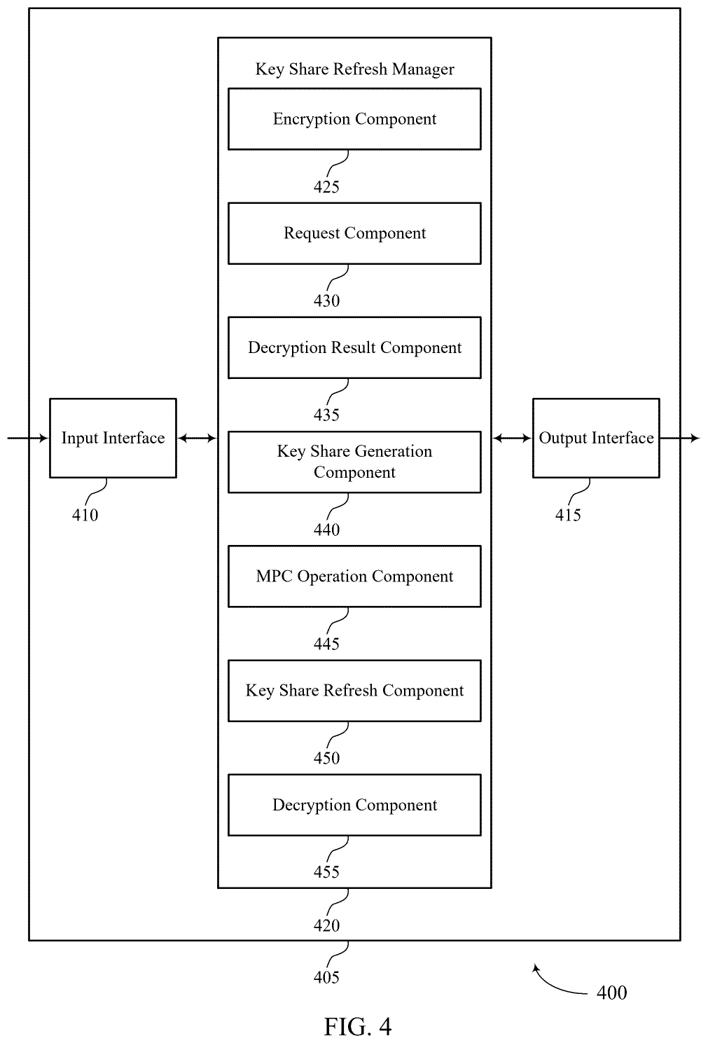

FIG. 4 shows a block diagram 400 of a device 405 that supports keyshare refresh via threshold encryption key in accordance with aspects of the present disclosure. The device 405 may include an input interface 410, an output interface 415, and a key share refresh manager 420. The device 405, or one of more components of the device 405 (e.g., the input interface 410, the output interface 415, the key share refresh manager 420), may include at least one processor, which may be coupled with at least one memory, to support the described techniques. Each of these components may be in communication with one another (e.g., via one or more buses).

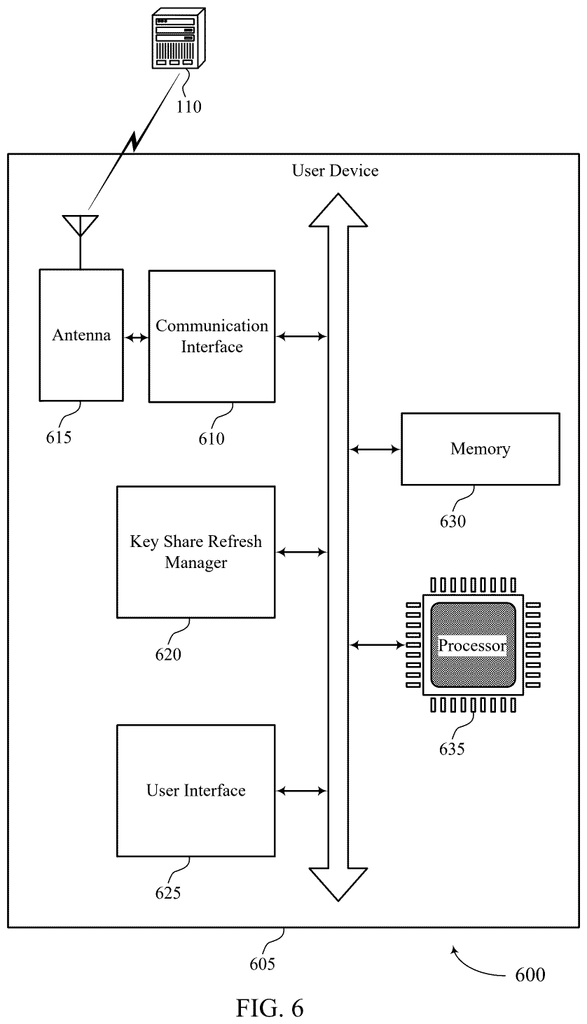

The input interface 410 may manage input signaling for the user device 405. For example, the input interface 410 may receive input signaling (e.g., messages, packets, data, instructions, commands, transactions, or any other form of encoded information) from other systems or devices. The input interface 410 may send signaling corresponding to (e.g., representative of or otherwise based on) such input signaling to other components of the user device 405 for processing. For example, the input interface 410 may transmit such corresponding signaling to the key share refresh manager 420 to support keyshare refresh via threshold encryption key. In some cases, the input interface 410 may be a component of a 610 as described with reference to FIG. 6.

The output interface 415 may manage output signaling for the device 405. For example, the output interface 415 may receive signaling from other components of the device 405, such as the key share refresh manager 420, and may transmit such output signaling corresponding to (e.g., representative of or otherwise based on) such signaling to other systems or devices. In some cases, the output interface 415 may be a component of a user interface 625 as described with reference to FIG. 6.

For example, the key share refresh manager 420 may include an encryption component 425, a request component 430, a decryption result component 435, a key share generation component 440, an MPC operation component 445, a key share refresh component 450, a decryption component 455, or any combination thereof. In some examples, the key share refresh manager 420, or various components thereof, may be configured to perform various operations (e.g., receiving, monitoring, transmitting) using or otherwise in cooperation with the input interface 410, the output interface 415, or both. For example, the key share refresh manager 420 may receive information from the input interface 410, send information to the output interface 415, or be integrated in combination with the input interface 410, the output interface 415, or both to receive information, transmit information, or perform various other operations as described herein.

The key share refresh manager 420 may support key management in accordance with examples as disclosed herein. The encryption component 425 may be configured as or otherwise support a means for encrypting a key share via a public threshold encryption key, wherein the key share is of a plurality of key shares associated with a cryptographic key. The request component 430 may be configured as or otherwise support a means for transmitting, in accordance with a multi-party computation operation, one or more requests to a plurality of parties having respective private key shares of a private threshold decryption key corresponding to the public threshold encryption key. The decryption result component 435 may be configured as or otherwise support a means for receiving, in response to the one or more requests, a plurality of partial decryption results from at least a subset of the plurality of parties having the respective private key shares of the private threshold decryption key. The key share generation component 440 may be configured as or otherwise support a means for combining the plurality of partial decryption results to generate the key share. The MPC operation component 445 may be configured as or otherwise support a means for executing a portion of the multi-party computation operation using the key share resulting from the combination of the plurality of partial decryption results. The key share refresh component 450 may be configured as or otherwise support a means for obtaining, after executing the portion of the multi-party computation operation and in accordance with a first key share refresh operation for the cryptographic key, a new key share of the cryptographic key. The encryption component 425 may be configured as or otherwise support a means for encrypting the new key share using the public threshold encryption key.

Additionally, or alternatively, the key share refresh manager 420 may support key management in accordance with examples as disclosed herein. The request component 430 may be configured as or otherwise support a means for receiving, in accordance with a multi-party computation operation at one or more parties of a plurality of parties having respective key shares of a cryptographic key, a request to decrypt a respective key share of the cryptographic key that is encrypted using a public threshold encryption key. The decryption component 455 may be configured as or otherwise support a means for decrypting, based at least in part on receiving the request and via a private key share of a private threshold decryption key corresponding to the public threshold encryption key, one or more ciphertexts associated with the request. The decryption result component 435 may be configured as or otherwise support a means for transmitting, in response to the request and after decrypting the one or more ciphertexts, one or more partial decryption results to the one or more parties. The key share refresh component 450 may be configured as or otherwise support a means for obtaining, in accordance with a key share refresh operation for the private threshold decryption key, a new private key share of the private threshold decryption key.

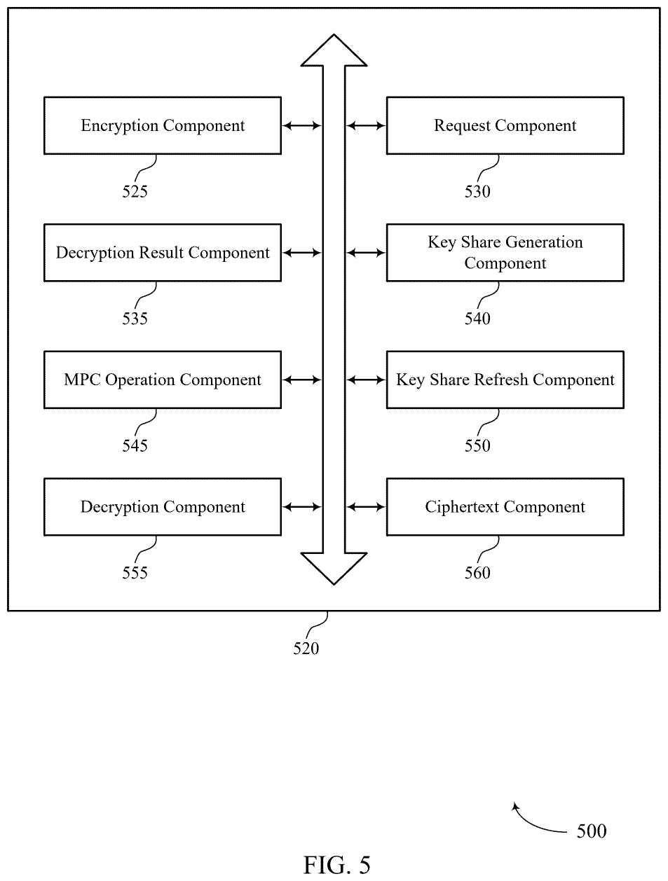

FIG. 5 shows a block diagram 500 of a key share refresh manager 520 that supports keyshare refresh via threshold encryption key in accordance with aspects of the present disclosure. The key share refresh manager 520 may be an example of a key share refresh manager 420, as described herein. The key share refresh manager 520, or various components thereof, may be an example of means for performing various aspects of keyshare refresh via threshold encryption key as described herein. For example, the key share refresh manager 520 may include an encryption component 525, a request component 530, a decryption result component 535, a key share generation component 540, an MPC operation component 545, a key share refresh component 550, a decryption component 555, a ciphertext component 560, or any combination thereof. Each of these components may communicate, directly or indirectly, with one another (e.g., via one or more buses, communications links, communications interfaces, or any combination thereof).

The key share refresh manager 520 may support key management in accordance with examples as disclosed herein. The encryption component 525 may be configured as or otherwise support a means for encrypting a key share via a public threshold encryption key, wherein the key share is of a plurality of key shares associated with a cryptographic key. The request component 530 may be configured as or otherwise support a means for transmitting, in accordance with a multi-party computation operation, one or more requests to a plurality of parties having respective private key shares of a private threshold decryption key corresponding to the public threshold encryption key. The decryption result component 535 may be configured as or otherwise support a means for receiving, in response to the one or more requests, a plurality of partial decryption results from at least a subset of the plurality of parties having the respective private key shares of the private threshold decryption key. The key share generation component 540 may be configured as or otherwise support a means for combining the plurality of partial decryption results to generate the key share. The MPC operation component 545 may be configured as or otherwise support a means for executing a portion of the multi-party computation operation using the key share resulting from the combination of the plurality of partial decryption results. The key share refresh component 550 may be configured as or otherwise support a means for obtaining, after executing the portion of the multi-party computation operation and in accordance with a first key share refresh operation for the cryptographic key, a new key share of the cryptographic key. In some examples, the encryption component 525 may be configured as or otherwise support a means for encrypting the new key share using the public threshold encryption key.

In some examples, the ciphertext component 560 may be configured as or otherwise support a means for generating, as a result of encrypting the key share via the public threshold encryption key, a first ciphertext, wherein the one or more requests comprise the first ciphertext.

In some examples, the first key share refresh operation for the plurality of key shares of the cryptographic key comprises generation of a second plurality of key shares that replace the plurality of key shares of the cryptographic key.

In some examples, the key share refresh operation for the respective private key shares of the private threshold decryption key comprises generation of a second plurality of private key shares replacing the respective private key shares of the private threshold decryption key.

In some examples, the multi-party computation operation is executed in accordance with execution of a threshold quantity of portions of the multi-party computation operation using at least a threshold quantity of key shares of the cryptographic key.

In some examples, a quantity of the subset of the plurality of parties satisfies a threshold quantity of decryption results combinable to generate the key share.

In some examples, to support executing the portion of the multi-party computation operation, the MPC operation component 545 may be configured as or otherwise support a means for executing a signing operation using the key share resulting from the combination of the plurality of partial decryption results.

In some examples, to support executing the portion of the multi-party computation operation, the MPC operation component 545 may be configured as or otherwise support a means for executing a decryption operation using the key share resulting from the combination of the plurality of partial decryption results.

Additionally, or alternatively, the key share refresh manager 520 may support key management in accordance with examples as disclosed herein. In some examples, the request component 530 may be configured as or otherwise support a means for receiving, in accordance with a multi-party computation operation at one or more parties of a plurality of parties having respective key shares of a cryptographic key, a request to decrypt a respective key share of the cryptographic key that is encrypted using a public threshold encryption key. The decryption component 555 may be configured as or otherwise support a means for decrypting, based at least in part on receiving the request and via a private key share of a private threshold decryption key corresponding to the public threshold encryption key, one or more ciphertexts associated with the request. In some examples, the decryption result component 535 may be configured as or otherwise support a means for transmitting, in response to the request and after decrypting the one or more ciphertexts, one or more partial decryption results to the one or more parties. In some examples, the key share refresh component 550 may be configured as or otherwise support a means for obtaining, in accordance with a key share refresh operation for the private threshold decryption key, a new private key share of the private threshold decryption key.

In some examples, to support obtaining the new private key share, the key share refresh component 550 may be configured as or otherwise support a means for obtaining the new private key share in accordance with the key share refresh operation, wherein the key share refresh operation occurs periodically for the private threshold decryption key.

In some examples, to support obtaining the new private key share, the key share refresh component 550 may be configured as or otherwise support a means for obtaining the new private key share in response to transmitting the one or more partial decryption results, wherein transmitting the one or more partial decryption results causes the key share refresh operation for the private threshold decryption key.

FIG. 6 shows a diagram of a system 600 including a device 605 that supports keyshare refresh via threshold encryption key in accordance with aspects of the present disclosure. The device 605 may be an example of or include components of a device 405 as described herein. The device 605 may include components for a key share refresh via a threshold encryption key including components for transmitting and receiving communications, such as a key share refresh manager 620, a communication interface 610, one or more antennas 615, a user interface 625, at least one memory 630, and at least one processor 635. Each of these components may communicate, directly or indirectly, with one another (e.g., via one or more buses, communications links, communications interfaces, or any combination thereof).

The communication interface 610 may manage input and output signals for the device 605 via the antenna 615. For example, the communication interface 610 may enable the user device 605 to exchange information (e.g., input information, output information, or both) with other systems or devices, such as custodial token platform 110 (e.g., supported by one or more servers), via one or more wired or wireless communication links. The communication interface 610 may also utilize or interact with antenna 615 to support communication with other systems or devices. In some cases, the communication interface 610 may represent a physical connection or port to an external peripheral, such as a hardware wallet device. In some cases, the communication interface 610 may utilize an operating system such as iOS®, ANDROID®, MS-DOS®, MS-WINDOWS®, OS/2®, UNIX®, LINUX®, or another known operating system. The communication interface 610 may be implemented as part of the processor 635.

In some cases, the device 605 may include a single antenna 615. However, in some other cases, the device 605 may have more than one antenna 615, which may be capable of concurrently transmitting or receiving multiple wireless transmissions. The communication interface 610 may communicate bi-directionally, via the one or more antennas 615, wired, or wireless links as described herein. For example, the communication interface 610 may represent a wireless transceiver and may communicate bi-directionally with another wireless transceiver. The communication interface 610 may also include a modem to modulate the packets, to provide the modulated packets to one or more antennas 615 for transmission, and to demodulate packets received from the one or more antennas 615.

The user interface 625 may represent interact with a keyboard, a mouse, a touchscreen, a microphone, or a similar device or component. In some cases, a user may interact with the user interface 625. In other cases, the user interface 625 may operate automatically without user interaction. The user interface 625 may display or output information such as information received from other systems or devices or information to be transmitted to other systems or devices.

The memory 630 may include RAM and ROM. The memory 630 may store computer-readable, computer-executable software including instructions that, when executed, cause at least one processor 635 to perform various functions described herein. In some cases, the memory 630 may contain, among other things, a BIOS which may control basic hardware or software operation such as the interaction with peripheral components or devices. The memory 630 may be an example of a single memory or multiple memories. For example, the user device 605 may include one or more memories 630.

The processor 635 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 635 may be configured to operate a memory array using a memory controller. In other cases, a memory controller may be integrated into the processor 635. The processor 635 may be configured to execute computer-readable instructions stored in at least one memory 630 to perform various functions (e.g., functions or tasks supporting a method and system for keyshare refresh via threshold encryption key). Though a single processor 635 is depicted in the example of FIG. 6, it is to be understood that the user device 605 may include any quantity of one or more of processors 635 and that a group of processors 635 may collectively perform one or more functions ascribed herein to a processor, such as the processor 635. The processor 635 may be an example of a single processor or multiple processors. For example, the device 605 may include one or more processors 635.

The key share refresh manager 620 may support key management in accordance with examples as disclosed herein. For example, the key share refresh manager 620 may be configured as or otherwise support a means for encrypting a key share via a public threshold encryption key, wherein the key share is of a plurality of key shares associated with a cryptographic key. The key share refresh manager 620 may be configured as or otherwise support a means for transmitting, in accordance with a multi-party computation operation, one or more requests to a plurality of parties having respective private key shares of a private threshold decryption key corresponding to the public threshold encryption key. The key share refresh manager 620 may be configured as or otherwise support a means for receiving, in response to the one or more requests, a plurality of partial decryption results from at least a subset of the plurality of parties having the respective private key shares of the private threshold decryption key. The key share refresh manager 620 may be configured as or otherwise support a means for combining the plurality of partial decryption results to generate the key share. The key share refresh manager 620 may be configured as or otherwise support a means for executing a portion of the multi-party computation operation using the key share resulting from the combination of the plurality of partial decryption results. The key share refresh manager 620 may be configured as or otherwise support a means for obtaining, after executing the portion of the multi-party computation operation and in accordance with a first key share refresh operation for the cryptographic key, a new key share of the cryptographic key. The key share refresh manager 620 may be configured as or otherwise support a means for encrypting the new key share using the public threshold encryption key.

Additionally, or alternatively, the key share refresh manager 620 may support key management in accordance with examples as disclosed herein. For example, the key share refresh manager 620 may be configured as or otherwise support a means for receiving, in accordance with a multi-party computation operation at one or more parties of a plurality of parties having respective key shares of a cryptographic key, a request to decrypt a respective key share of the cryptographic key that is encrypted using a public threshold encryption key. The key share refresh manager 620 may be configured as or otherwise support a means for decrypting, basing at least in part on receiving the request and via a private key share of a private threshold decryption key corresponding to the public threshold encryption key, one or more ciphertexts associated with the request. The key share refresh manager 620 may be configured as or otherwise support a means for transmitting, in response to the request and after decrypting the one or more ciphertexts, one or more partial decryption results to the one or more parties. The key share refresh manager 620 may be configured as or otherwise support a means for obtaining, in accordance with a key share refresh operation for the private threshold decryption key, a new private key share of the private threshold decryption key.

By including or configuring the key share refresh manager 620 in accordance with examples as described herein, the device 605 may support techniques for improved efficiency related to a key share refresh operation.

The key share refresh manager 620 may include an application (e.g., “app”), program, software, extension, or other component which is configured to facilitate communications with a custodial token platform 110 on a server, one or more nodes of a blockchain network 105, other user devices 605, and other devices or systems. For example, the key share refresh manager 620 may be an application executable on the user device 605, and the key share refresh manager 620 may be configured to receive data from a custodial token platform 110, transmit data to the custodial token platform 110, process such data, and cause presentation of such data to a user via a user interface 625. The key share refresh manager 620 may be an example of a wallet application, a wallet device, or both, and may be associated with a wallet address and may access or use a private key to sign messages to facilitate transfer of crypto tokens, messages, transactions, or the like via a blockchain distributed data store.

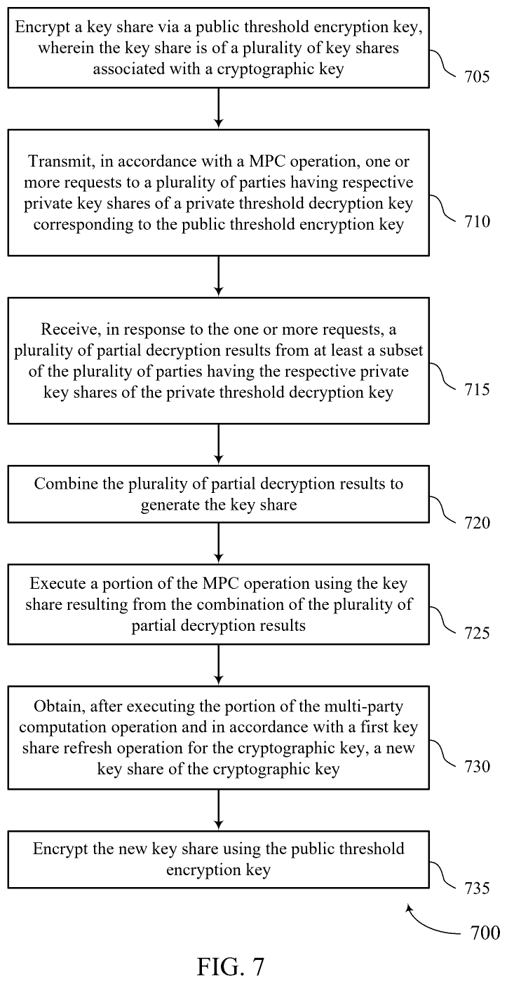

FIG. 7 shows a flowchart illustrating a method 700 that supports keyshare refresh via threshold encryption key in accordance with aspects of the present disclosure. The operations of the method 700 may be implemented by a user device or its components as described herein. For example, the operations of the method 700 may be performed by a user device as described with reference to FIGS. 1 through 6. In some examples, a user device may execute a set of instructions to control the functional elements of the user device to perform the described functions. Additionally, or alternatively, the user device may perform aspects of the described functions using special-purpose hardware.

At 705, the method may include encrypting a key share via a public threshold encryption key, wherein the key share is of a plurality of key shares associated with a cryptographic key. The operations of 705 may be performed in accordance with examples as disclosed herein. In some examples, aspects of the operations of 705 may be performed by an encryption component 525 as described with reference to FIG. 5.

At 710, the method may include transmitting, in accordance with a multi-party computation operation, one or more requests to a plurality of parties having respective private key shares of a private threshold decryption key corresponding to the public threshold encryption key. The operations of 710 may be performed in accordance with examples as disclosed herein. In some examples, aspects of the operations of 710 may be performed by a request component 530 as described with reference to FIG. 5.

At 715, the method may include receiving, in response to the one or more requests, a plurality of partial decryption results from at least a subset of the plurality of parties having the respective private key shares of the private threshold decryption key. The operations of 715 may be performed in accordance with examples as disclosed herein. In some examples, aspects of the operations of 715 may be performed by a decryption result component 535 as described with reference to FIG. 5.

At 720, the method may include combining the plurality of partial decryption results to generate the key share. The operations of 720 may be performed in accordance with examples as disclosed herein. In some examples, aspects of the operations of 720 may be performed by a key share generation component 540 as described with reference to FIG. 5.

At 725, the method may include executing a portion of the multi-party computation operation using the key share resulting from the combination of the plurality of partial decryption results. The operations of 725 may be performed in accordance with examples as disclosed herein. In some examples, aspects of the operations of 725 may be performed by an MPC operation component 545 as described with reference to FIG. 5.

At 730, the method may include obtaining, after executing the portion of the multi-party computation operation and in accordance with a first key share refresh operation for the cryptographic key, a new key share of the cryptographic key. The operations of 730 may be performed in accordance with examples as disclosed herein. In some examples, aspects of the operations of 730 may be performed by a key share refresh component 550 as described with reference to FIG. 5.

At 735, the method may include encrypting the new key share using the public threshold encryption key. The operations of 735 may be performed in accordance with examples as disclosed herein. In some examples, aspects of the operations of 735 may be performed by an encryption component 525 as described with reference to FIG. 5.

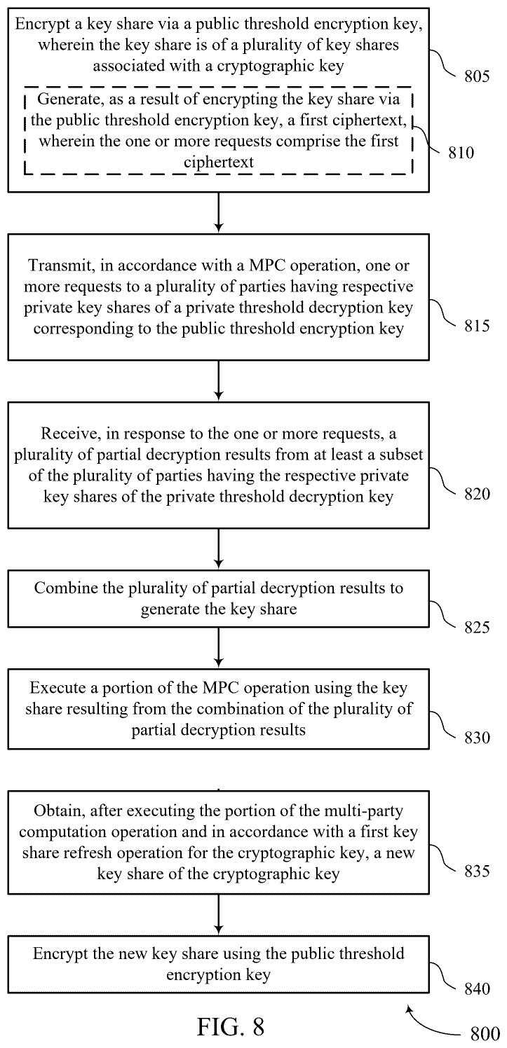

FIG. 8 shows a flowchart illustrating a method 800 that supports keyshare refresh via threshold encryption key in accordance with aspects of the present disclosure. The operations of the method 800 may be implemented by a user device or its components as described herein. For example, the operations of the method 800 may be performed by a user device as described with reference to FIGS. 1 through 6. In some examples, a user device may execute a set of instructions to control the functional elements of the user device to perform the described functions. Additionally, or alternatively, the user device may perform aspects of the described functions using special-purpose hardware.

At 805, the method may include encrypting a key share via a public threshold encryption key, wherein the key share is of a plurality of key shares associated with a cryptographic key. The operations of 805 may be performed in accordance with examples as disclosed herein. In some examples, aspects of the operations of 805 may be performed by an encryption component 525 as described with reference to FIG. 5.

At 810, the method may include generating, as a result of encrypting the key share via the public threshold encryption key, a first ciphertext, wherein the one or more requests comprise the first ciphertext. The operations of 810 may be performed in accordance with examples as disclosed herein. In some examples, aspects of the operations of 810 may be performed by a ciphertext component 560 as described with reference to FIG. 5.

At 815, the method may include transmitting, in accordance with a multi-party computation operation, one or more requests to a plurality of parties having respective private key shares of a private threshold decryption key corresponding to the public threshold encryption key. The operations of 815 may be performed in accordance with examples as disclosed herein. In some examples, aspects of the operations of 815 may be performed by a request component 530 as described with reference to FIG. 5.

At 820, the method may include receiving, in response to the one or more requests, a plurality of partial decryption results from at least a subset of the plurality of parties having the respective private key shares of the private threshold decryption key. The operations of 820 may be performed in accordance with examples as disclosed herein. In some examples, aspects of the operations of 820 may be performed by a decryption result component 535 as described with reference to FIG. 5.

At 825, the method may include combining the plurality of partial decryption results to generate the key share. The operations of 825 may be performed in accordance with examples as disclosed herein. In some examples, aspects of the operations of 825 may be performed by a key share generation component 540 as described with reference to FIG. 5.

At 830, the method may include executing a portion of the multi-party computation operation using the key share resulting from the combination of the plurality of partial decryption results. The operations of 830 may be performed in accordance with examples as disclosed herein. In some examples, aspects of the operations of 830 may be performed by an MPC operation component 545 as described with reference to FIG. 5.

At 835, the method may include obtaining, after executing the portion of the multi-party computation operation and in accordance with a first key share refresh operation for the cryptographic key, a new key share of the cryptographic key. The operations of 835 may be performed in accordance with examples as disclosed herein. In some examples, aspects of the operations of 835 may be performed by a key share refresh component 550 as described with reference to FIG. 5.

At 840, the method may include encrypting the new key share using the public threshold encryption key. The operations of 840 may be performed in accordance with examples as disclosed herein. In some examples, aspects of the operations of 840 may be performed by an encryption component 525 as described with reference to FIG. 5.

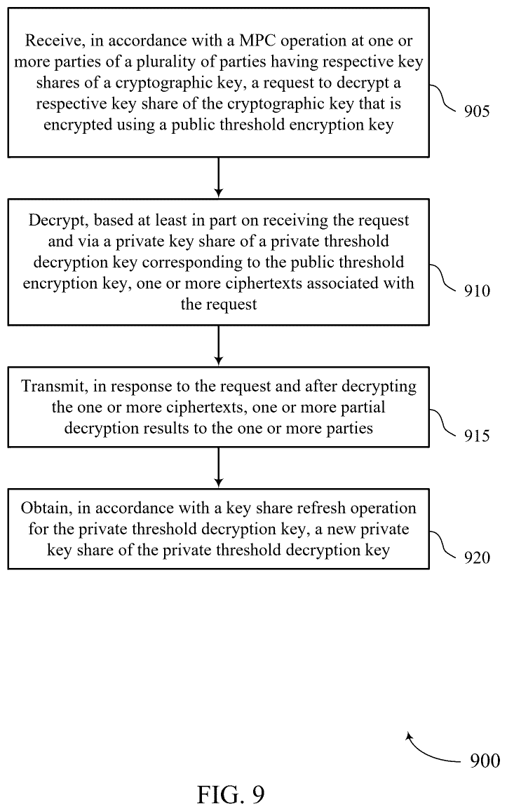

FIG. 9 shows a flowchart illustrating a method 900 that supports keyshare refresh via threshold encryption key in accordance with aspects of the present disclosure. The operations of the method 900 may be implemented by a user device or its components as described herein. For example, the operations of the method 900 may be performed by a user device as described with reference to FIGS. 1 through 6. In some examples, a user device may execute a set of instructions to control the functional elements of the user device to perform the described functions. Additionally, or alternatively, the user device may perform aspects of the described functions using special-purpose hardware.

At 905, the method may include receiving, in accordance with a multi-party computation operation at one or more parties of a plurality of parties having respective key shares of a cryptographic key, a request to decrypt a respective key share of the cryptographic key that is encrypted using a public threshold encryption key. The operations of 905 may be performed in accordance with examples as disclosed herein. In some examples, aspects of the operations of 905 may be performed by a request component 530 as described with reference to FIG. 5.

At 910, the method may include decrypting, based at least in part on receiving the request and via a private key share of a private threshold decryption key corresponding to the public threshold encryption key, one or more ciphertexts associated with the request. The operations of 910 may be performed in accordance with examples as disclosed herein. In some examples, aspects of the operations of 910 may be performed by a decryption component 555 as described with reference to FIG. 5.

At 915, the method may include transmitting, in response to the request and after decrypting the one or more ciphertexts, one or more partial decryption results to the one or more parties. The operations of 915 may be performed in accordance with examples as disclosed herein. In some examples, aspects of the operations of 915 may be performed by a decryption result component 535 as described with reference to FIG. 5.

At 920, the method may include obtaining, in accordance with a key share refresh operation for the private threshold decryption key, a new private key share of the private threshold decryption key. The operations of 920 may be performed in accordance with examples as disclosed herein. In some examples, aspects of the operations of 920 may be performed by a key share refresh component 550 as described with reference to FIG. 5.

A method for key management by an apparatus is described. The method may include encrypting a key share via a public threshold encryption key, wherein the key share is of a plurality of key shares associated with a cryptographic key, transmitting, in accordance with a multi-party computation operation, one or more requests to a plurality of parties having respective private key shares of a private threshold decryption key corresponding to the public threshold encryption key, receiving, in response to the one or more requests, a plurality of partial decryption results from at least a subset of the plurality of parties having the respective private key shares of the private threshold decryption key, combining the plurality of partial decryption results to generate the key share, executing a portion of the multi-party computation operation using the key share resulting from the combination of the plurality of partial decryption results, obtaining, after executing the portion of the multi-party computation operation and in accordance with a first key share refresh operation for the cryptographic key, a new key share of the cryptographic key, and encrypting the new key share using the public threshold encryption key.

An apparatus for key management is described. The apparatus may include one or more memories storing processor executable code, and one or more processors coupled with the one or more memories. The one or more processors may individually or collectively be operable to execute the code to cause the apparatus to encrypt a key share via a public threshold encryption key, wherein the key share is of a plurality of key shares associated with a cryptographic key, transmit, in accordance with a multi-party computation operation, one or more requests to a plurality of parties having respective private key shares of a private threshold decryption key corresponding to the public threshold encryption key, receive, in response to the one or more requests, a plurality of partial decryption results from at least a subset of the plurality of parties having the respective private key shares of the private threshold decryption key, combine the plurality of partial decryption results to generate the key share, execute a portion of the multi-party computation operation using the key share resulting from the combination of the plurality of partial decryption results, obtain, after executing the portion of the multi-party computation operation and in accordance with a first key share refresh operation for the cryptographic key, a new key share of the cryptographic key, and encrypt the new key share using the public threshold encryption key.

Another apparatus for key management is described. The apparatus may include means for encrypting a key share via a public threshold encryption key, wherein the key share is of a plurality of key shares associated with a cryptographic key, means for transmitting, in accordance with a multi-party computation operation, one or more requests to a plurality of parties having respective private key shares of a private threshold decryption key corresponding to the public threshold encryption key, means for receiving, in response to the one or more requests, a plurality of partial decryption results from at least a subset of the plurality of parties having the respective private key shares of the private threshold decryption key, means for combining the plurality of partial decryption results to generate the key share, means for executing a portion of the multi-party computation operation using the key share resulting from the combination of the plurality of partial decryption results, means for obtaining, after executing the portion of the multi-party computation operation and in accordance with a first key share refresh operation for the cryptographic key, a new key share of the cryptographic key, and means for encrypting the new key share using the public threshold encryption key.

A non-transitory computer-readable medium storing code for key management is described. The code may include instructions executable by one or more processors to encrypt a key share via a public threshold encryption key, wherein the key share is of a plurality of key shares associated with a cryptographic key, transmit, in accordance with a multi-party computation operation, one or more requests to a plurality of parties having respective private key shares of a private threshold decryption key corresponding to the public threshold encryption key, receive, in response to the one or more requests, a plurality of partial decryption results from at least a subset of the plurality of parties having the respective private key shares of the private threshold decryption key, combine the plurality of partial decryption results to generate the key share, execute a portion of the multi-party computation operation using the key share resulting from the combination of the plurality of partial decryption results, obtain, after executing the portion of the multi-party computation operation and in accordance with a first key share refresh operation for the cryptographic key, a new key share of the cryptographic key, and encrypt the new key share using the public threshold encryption key.

Some examples of the method, apparatus, and non-transitory computer-readable medium described herein may further include operations, features, means, or instructions for generating, as a result of encrypting the key share via the public threshold encryption key, a first ciphertext, wherein the one or more requests comprise the first ciphertext.

In some examples of the method, apparatus, and non-transitory computer-readable medium described herein, the first key share refresh operation for the plurality of key shares of the cryptographic key comprises generation of a second plurality of key shares that replace the plurality of key shares of the cryptographic key.

In some examples of the method, apparatus, and non-transitory computer-readable medium described herein, the key share refresh operation for the respective private key shares of the private threshold decryption key comprises generation of a second plurality of private key shares replacing the respective private key shares of the private threshold decryption key.

In some examples of the method, apparatus, and non-transitory computer-readable medium described herein, the multi-party computation operation may be executed in accordance with execution of a threshold quantity of portions of the multi-party computation operation using at least a threshold quantity of key shares of the cryptographic key.

In some examples of the method, apparatus, and non-transitory computer-readable medium described herein, a quantity of the subset of the plurality of parties satisfies a threshold quantity of decryption results combinable to generate the key share.

In some examples of the method, apparatus, and non-transitory computer-readable medium described herein, executing the portion of the multi-party computation operation may include operations, features, means, or instructions for executing a signing operation using the key share resulting from the combination of the plurality of partial decryption results.

In some examples of the method, apparatus, and non-transitory computer-readable medium described herein, executing the portion of the multi-party computation operation may include operations, features, means, or instructions for executing a decryption operation using the key share resulting from the combination of the plurality of partial decryption results.

A method for key management by an apparatus is described. The method may include receiving, in accordance with a multi-party computation operation at one or more parties of a plurality of parties having respective key shares of a cryptographic key, a request to decrypt a respective key share of the cryptographic key that is encrypted using a public threshold encryption key, decrypting, based at least in part on receiving the request and via a private key share of a private threshold decryption key corresponding to the public threshold encryption key, one or more ciphertexts associated with the request, transmitting, in response to the request and after decrypting the one or more ciphertexts, one or more partial decryption results to the one or more parties, and obtaining, in accordance with a key share refresh operation for the private threshold decryption key, a new private key share of the private threshold decryption key.

An apparatus for key management is described. The apparatus may include one or more memories storing processor executable code, and one or more processors coupled with the one or more memories. The one or more processors may individually or collectively be operable to execute the code to cause the apparatus to receive, in accordance with a multi-party computation operation at one or more parties of a plurality of parties having respective key shares of a cryptographic key, a request to decrypt a respective key share of the cryptographic key that is encrypted using a public threshold encryption key, decrypt, based at least in part on receiving the request and via a private key share of a private threshold decryption key corresponding to the public threshold encryption key, one or more ciphertexts associated with the request, transmit, in response to the request and after decrypting the one or more ciphertexts, one or more partial decryption results to the one or more parties, and obtain, in accordance with a key share refresh operation for the private threshold decryption key, a new private key share of the private threshold decryption key.

Another apparatus for key management is described. The apparatus may include means for receiving, in accordance with a multi-party computation operation at one or more parties of a plurality of parties having respective key shares of a cryptographic key, a request to decrypt a respective key share of the cryptographic key that is encrypted using a public threshold encryption key, means for decrypting, based at least in part on receiving the request and via a private key share of a private threshold decryption key corresponding to the public threshold encryption key, one or more ciphertexts associated with the request, means for transmitting, in response to the request and after decrypting the one or more ciphertexts, one or more partial decryption results to the one or more parties, and means for obtaining, in accordance with a key share refresh operation for the private threshold decryption key, a new private key share of the private threshold decryption key.

A non-transitory computer-readable medium storing code for key management is described. The code may include instructions executable by one or more processors to receive, in accordance with a multi-party computation operation at one or more parties of a plurality of parties having respective key shares of a cryptographic key, a request to decrypt a respective key share of the cryptographic key that is encrypted using a public threshold encryption key, decrypt, based at least in part on receiving the request and via a private key share of a private threshold decryption key corresponding to the public threshold encryption key, one or more ciphertexts associated with the request, transmit, in response to the request and after decrypting the one or more ciphertexts, one or more partial decryption results to the one or more parties, and obtain, in accordance with a key share refresh operation for the private threshold decryption key, a new private key share of the private threshold decryption key.

In some examples of the method, apparatus, and non-transitory computer-readable medium described herein, obtaining the new private key share may include operations, features, means, or instructions for obtaining the new private key share in accordance with the key share refresh operation, wherein the key share refresh operation occurs periodically for the private threshold decryption key.

In some examples of the method, apparatus, and non-transitory computer-readable medium described herein, obtaining the new private key share may include operations, features, means, or instructions for obtaining the new private key share in response to transmitting the one or more partial decryption results, wherein transmitting the one or more partial decryption results causes the key share refresh operation for the private threshold decryption key.

It should be noted that the methods described above describe possible implementations, and that the operations and the steps may be rearranged or otherwise modified and that other implementations are possible. Furthermore, aspects from two or more of the methods may be combined.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Further, a system as used herein may be a collection of devices, a single device, or aspects within a single device.

Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, EEPROM) compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for key management, comprising:
encrypting a key share via a public threshold encryption key, wherein the key share is of a plurality of key shares associated with a cryptographic key;
transmitting, in accordance with a multi-party computation operation, one or more requests to a plurality of parties having respective private key shares of a private threshold decryption key corresponding to the public threshold encryption key;
receiving, in response to the one or more requests, a plurality of partial decryption results from at least a subset of the plurality of parties having the respective private key shares of the private threshold decryption key;
combining the plurality of partial decryption results to generate the key share;
executing a portion of the multi-party computation operation using the key share resulting from the combination of the plurality of partial decryption results;
obtaining, after executing the portion of the multi-party computation operation and in accordance with a first key share refresh operation for the cryptographic key, a new key share of the cryptographic key; and
encrypting the new key share using the public threshold encryption key.

2. The method of claim 1, further comprising:
generating, as a result of encrypting the key share via the public threshold encryption key, a first ciphertext, wherein the one or more requests comprise the first ciphertext.

3. The method of claim 1, wherein the first key share refresh operation for the plurality of key shares of the cryptographic key comprises generation of a second plurality of key shares that replace the plurality of key shares of the cryptographic key.

4. The method of claim 1, wherein the key share refresh operation for the respective private key shares of the private threshold decryption key comprises generation of a second plurality of private key shares replacing the respective private key shares of the private threshold decryption key.

5. The method of claim 1, wherein the multi-party computation operation is executed in accordance with execution of a threshold quantity of portions of the multi-party computation operation using at least a threshold quantity of key shares of the cryptographic key.

6. The method of claim 1, wherein a quantity of the subset of the plurality of parties satisfies a threshold quantity of decryption results combinable to generate the key share.

7. The method of claim 1, wherein executing the portion of the multi-party computation operation comprises:
executing a signing operation using the key share resulting from the combination of the plurality of partial decryption results.

8. The method of claim 1, wherein executing the portion of the multi-party computation operation comprises:
executing a decryption operation using the key share resulting from the combination of the plurality of partial decryption results.

9. A method for key management, comprising:
receiving, in accordance with a multi-party computation operation at one or more parties of a plurality of parties having respective key shares of a cryptographic key, a request to decrypt a respective key share of the cryptographic key that is encrypted using a public threshold encryption key;
decrypting, based at least in part on receiving the request and via a private key share of a private threshold decryption key corresponding to the public threshold encryption key, one or more ciphertexts associated with the request;
transmitting, in response to the request and after decrypting the one or more ciphertexts, one or more partial decryption results to the one or more parties; and
obtaining, in accordance with a key share refresh operation for the private threshold decryption key, a new private key share of the private threshold decryption key.

10. The method of claim 9, wherein obtaining the new private key share comprises:
obtaining the new private key share in accordance with the key share refresh operation, wherein the key share refresh operation occurs periodically for the private threshold decryption key.

11. The method of claim 9, wherein obtaining the new private key share comprises:
obtaining the new private key share in response to transmitting the one or more partial decryption results, wherein transmitting the one or more partial decryption results causes the key share refresh operation for the private threshold decryption key.

12. An apparatus for key management, comprising:
one or more memories storing processor-executable code; and
one or more processors coupled with the one or more memories and individually or collectively operable to execute the code to cause the apparatus to:
encrypt a key share via a public threshold encryption key, wherein the key share is of a plurality of key shares associated with a cryptographic key;
transmit, in accordance with a multi-party computation operation, one or more requests to a plurality of parties having respective private key shares of a private threshold decryption key corresponding to the public threshold encryption key;
receive, in response to the one or more requests, a plurality of partial decryption results from at least a subset of the plurality of parties having the respective private key shares of the private threshold decryption key;
combine the plurality of partial decryption results to generate the key share;
execute a portion of the multi-party computation operation using the key share resulting from the combination of the plurality of partial decryption results;
obtain, after executing the portion of the multi-party computation operation and in accordance with a first key share refresh operation for the cryptographic key, a new key share of the cryptographic key; and
encrypt the new key share using the public threshold encryption key.

13. The apparatus of claim 12, wherein the one or more processors are individually or collectively further operable to execute the code to cause the apparatus to:
generate, as a result of encrypting the key share via the public threshold encryption key, a first ciphertext, wherein the one or more requests comprise the first ciphertext.

14. The apparatus of claim 12, wherein the first key share refresh operation for the plurality of key shares of the cryptographic key comprises generation of a second plurality of key shares that replace the plurality of key shares of the cryptographic key.

15. The apparatus of claim 12, wherein the key share refresh operation for the respective private key shares of the private threshold decryption key comprises generation of a second plurality of private key shares replacing the respective private key shares of the private threshold decryption key.

16. The apparatus of claim 12, wherein the multi-party computation operation is executed in accordance with execution of a threshold quantity of portions of the multi-party computation operation using at least a threshold quantity of key shares of the cryptographic key.

17. The apparatus of claim 12, wherein a quantity of the subset of the plurality of parties satisfies a threshold quantity of decryption results combinable to generate the key share.

18. The apparatus of claim 12, wherein, to execute the portion of the multi-party computation operation, the one or more processors are individually or collectively operable to execute the code to cause the apparatus to:
execute a signing operation using the key share resulting from the combination of the plurality of partial decryption results.

19. The apparatus of claim 12, wherein, to execute the portion of the multi-party computation operation, the one or more processors are individually or collectively operable to execute the code to cause the apparatus to:
execute a decryption operation using the key share resulting from the combination of the plurality of partial decryption results.

20. An apparatus for key management, comprising:
one or more memories storing processor-executable code; and
one or more processors coupled with the one or more memories and individually or collectively operable to execute the code to cause the apparatus to:
receive, in accordance with a multi-party computation operation at one or more parties of a plurality of parties having respective key shares of a cryptographic key, a request to decrypt a respective key share of the cryptographic key that is encrypted using a public threshold encryption key;
decrypt, based at least in part on receiving the request and via a private key share of a private threshold decryption key corresponding to the public threshold encryption key, one or more ciphertexts associated with the request;
transmit, in response to the request and after decrypting the one or more ciphertexts, one or more partial decryption results to the one or more parties; and
obtain, in accordance with a key share refresh operation for the private threshold decryption key, a new private key share of the private threshold decryption key.

21. The apparatus of claim 20, wherein, to obtain the new private key share, the one or more processors are individually or collectively operable to execute the code to cause the apparatus to:
obtain the new private key share in accordance with the key share refresh operation, wherein the key share refresh operation occurs periodically for the private threshold decryption key.

22. The apparatus of claim 20, wherein, to obtain the new private key share, the one or more processors are individually or collectively operable to execute the code to cause the apparatus to:
obtain the new private key share in response to transmitting the one or more partial decryption results, wherein transmitting the one or more partial decryption results causes the key share refresh operation for the private threshold decryption key.
